(19) United States
(12) Patent Application Publication
(10) Pub. No.: US 2022/0092523 A1
(43) Pub. Date: Mar. 24, 2022

(54) INVENTORY MANAGEMENT SERVER, INVENTORY MANAGEMENT SYSTEM, INVENTORY MANAGEMENT METHOD, AND RECORDING MEDIUM

(71) Applicant: NEC Corporation, Minato-ku, Tokyo (JP)

(72) Inventor: Jun UCHIMURA, Tokyo (JP)

(73) Assignee: NEC Corporation, Minato-ku, Tokyo (JP)

(21) Appl. No.: 17/424,358

(22) PCT Filed: Mar. 9, 2020
(86) PCT No.: PCT/JP2020/009920

§ 371 Date: Jul. 20, 2021

(30) Foreign Application Priority Data
Mar. 22, 2019 (JP) 2019-054131

(51) Int. Cl. G06Q 10/08; G06Q 10/06

(52) U.S. Cl. CPC G06Q 10/087; G06Q 20/203; G06Q 10/06315

(57) ABSTRACT

There are provided an inventory management server, an inventory management system, an inventory management method, and an inventory management program for efficiently performing inventory management in a specific store such as a labor-saving store. The inventory management server 4 includes a generation unit 2 and a notification unit 3. The generation unit 2 generates stock shortage information including information for specifying a branch store and a stock quantity of a product when the stock quantity of the product in the branch store in which an employee of a flagship store replaces the product is equal to or less than a threshold. The notification unit 3 notifies the store terminal held by the employee of the stock shortage information.

### TECHNICAL FIELD

The present disclosure relates to an inventory management server, an inventory management system, an inventory management method, and an inventory management program.

### BACKGROUND ART

In the retail industry, inventory management of products in a store is necessary in order to reduce opportunity loss. As a method of inventory management, PTL 1 discloses a technique for resolving an imbalance in the stock of products among a plurality of stores. Patent Literature 2 discloses a technique for distributing stock products to each store or a base of each region in consideration of a return destination of a return product in an inventory.

### CITATION LIST

### Patent Literature

[PTL 1] JP 2009-217377 A

[PTL 2] JP 2018-156228 A

### SUMMARY OF INVENTION

### Technical Problem

However, PTL 1 and PTL 2 described above do not disclose a technique of managing the inventory of a normal store where an employee is stationed and the inventory of a labor-saving store or the like where no employee monitoring the inventory of products is present.

One object of the present disclosure is to provide an inventory management server or the like for solving the above-described problem and efficiently performing inventory management of products in a store such as a labor-saving store.

### Solution to Problem

An inventory management server according to one aspect of the present disclosure includes:

a generation means for generating stock shortage information including information for specifying a branch store and a stock quantity of a product when the stock quantity of the product in the branch store in which an employee of a flagship store replaces the product is equal to or less than a threshold; and

a notification means for notifying the store terminal of the stock shortage information.

An inventory management system according to one aspect of the present disclosure includes:

a first server that manages an inventory of a flagship store;

a second server that manages an inventory of a branch store in which an employee of the flagship store replaces a product; and

a store terminal,

in which the second server is communicably connected to the store terminal,

the second server includes a generation means for generating stock shortage information including information for specifying the branch store and a stock quantity of the product when the stock quantity of the product in the branch store is equal to or less than a threshold, and a notification means for notifying the store terminal of the stock shortage information, and

the store terminal includes a display unit that displays inventory information based on the stock shortage information.

An inventory management method according to one aspect of the present disclosure includes:

generating stock shortage information including information for specifying a branch store and a stock quantity of a product when the stock quantity of the product in the branch store in which an employee of a flagship store replaces the product is equal to or less than a threshold; and

notifying the store terminal of the stock shortage information.

An inventory management program according to one aspect of the present disclosure causes a computer to execute processing including:

generating stock shortage information including information for specifying a branch store and a stock quantity of a product when the stock quantity of the product in the branch store in which an employee of a flagship store replaces the product is equal to or less than a threshold; and

notifying the store terminal of the stock shortage information.

The inventory management program may be stored in a non-transitory computer-readable recording medium.

### Advantageous Effects of Invention

An effect of the present disclosure is that inventory management can be efficiently performed in a specific store such as a labor-saving store.

### BRIEF DESCRIPTION OF DRAWINGS

FIG. 1 is a block diagram illustrating a configuration of an inventory management system in a first example embodiment.

FIG. 2 is a diagram illustrating an example of a relationship among stores in the first example embodiment.

FIG. 3 is a diagram illustrating an example of inventory information data stored in an inventory storage unit.

FIG. 4 is a diagram illustrating an example of inventory information data stored in the inventory storage unit.

FIG. 5 is a diagram illustrating an example of inventory information data stored in the inventory storage unit.

FIG. 6 is a diagram illustrating an example of inventory information data stored in the inventory storage unit.

FIG. 7 is a flowchart illustrating an example of an operation of the inventory management system.

FIG. 8 is a block diagram illustrating a configuration of an inventory management server in a second example embodiment.

FIG. 9 is a block diagram illustrating an example of a hardware configuration of a computer.

### EXAMPLE EMBODIMENT

In the retail industry, for the purpose of improving operation efficiency and expanding to small trading zones, introduction of labor-saving or unmanned stores (hereinafter these are collectively referred to as “labor-saving stores”) has been promoted in which, for example, work of employees related to registration and settlement of products being purchased as well as customer service support, in-store monitoring, inventory management, facility management, and the like is reduced with a computer system, and the number of stationed employees is reduced or eliminated.

Generally, the labor-saving stores are smaller in size and have limited floor areas than normal stores. Unlike the normal stores located along public roads in urban areas and suburban areas, these labor-saving stores may be located also in, for example, specific places such as office buildings, factories, station premises, hotels, and apartment buildings.

Even in such a labor-saving store, inventory management of products in the store is necessary in order to reduce the loss of sales opportunities. That is, there is a need for a technique by which an employee of a normal store manages the inventory of a normal store where the employee is stationed and the inventory of a labor-saving store or the like where no employee monitoring the inventory of products is present. Accordingly, in the following example embodiment, an inventory management server and the like for an employee of a normal store to efficiently perform inventory management of products in a store such as a labor-saving store will be described.

Hereinafter, example embodiments will be described in detail with reference to the drawings. Note that in the drawings and the example embodiments described in the description, the same reference numerals are given to similar components, and the description thereof will be omitted as appropriate.

### First Example Embodiment

A first example embodiment will be described.

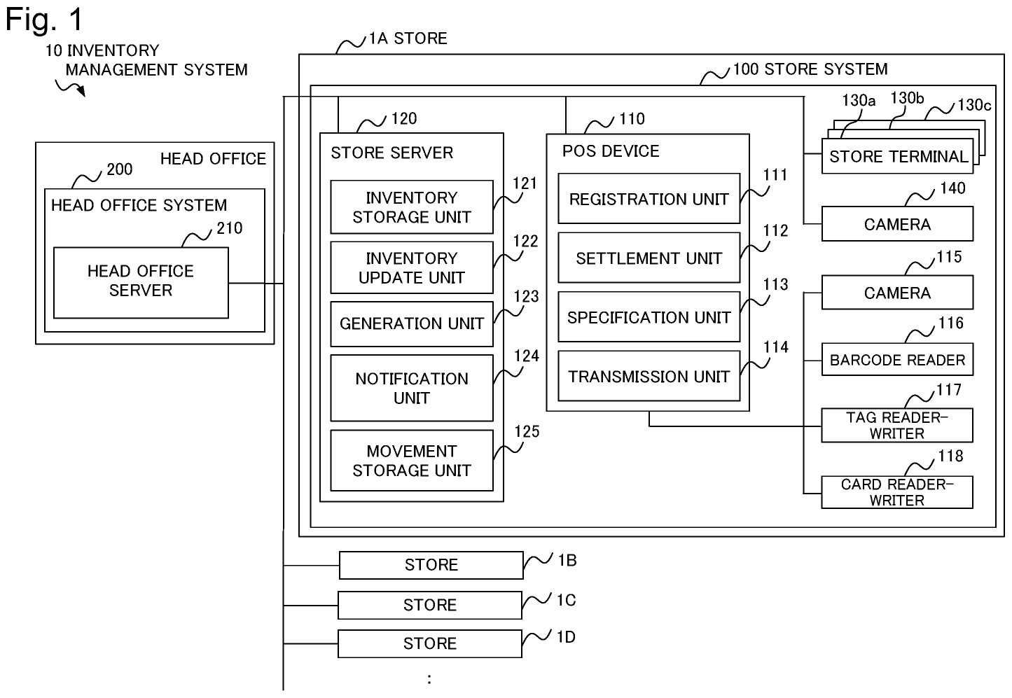

First, a configuration of an inventory management system according to the first example embodiment will be described. FIG. 1 is a block diagram illustrating a configuration of an inventory management system 10 according to the first example embodiment. Referring to FIG. 1, the inventory management system 10 includes a plurality of store systems 100 and a head office system 200. For example, the store system 100 is installed in each of stores 1A, 1B, 1C, and 1D (hereinafter collectively referred to as store 1) of a chain of convenience stores, supermarkets, or the like in the retail industry. The head office system 200 is installed, for example, in the head office of the chain. The store system 100 and the head office system 200 of each store 1 are connected by, for example, a communication network. The head office system 200 includes a head office server 210, and the head office server 210 performs product management, inventory management, and the like of the entire store.

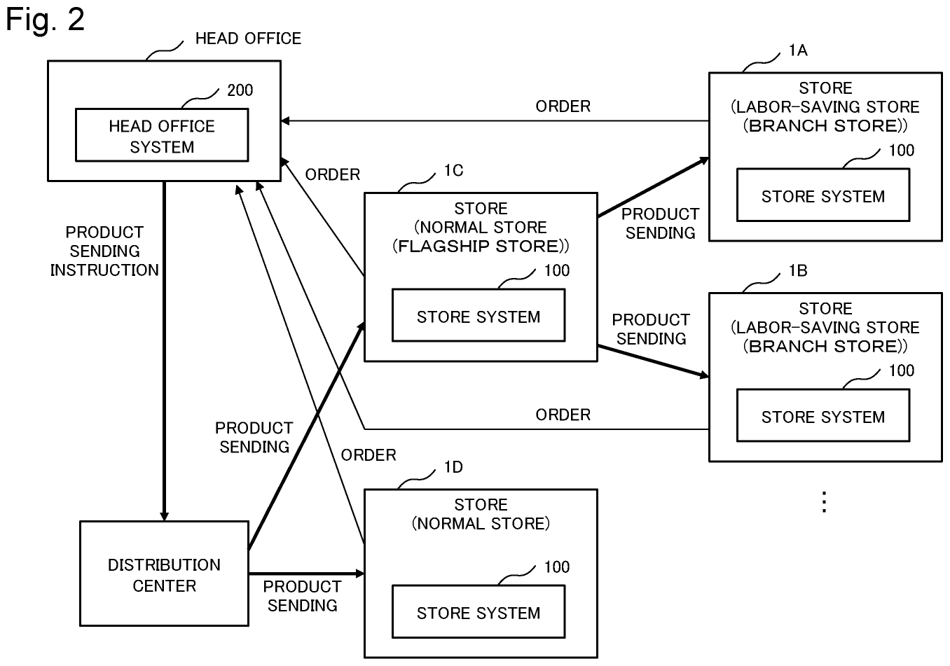

The store 1 may include a normal store and a labor-saving store. FIG. 2 is a diagram illustrating an example of a relationship between stores in the first example embodiment. The labor-saving store is a store in which, for example, at least a part of work of employees related to registration and settlement of products being purchased as well as customer service support, in-store monitoring, inventory management, facility management, and the like is reduced with a computer system as compared with the normal store in the chain or the like. The floor area of the labor-saving store may be smaller than that of the normal store.

The normal store may manage a nearby labor-saving store. Here, the normal store that manages the labor-saving store is referred to as a flagship store (hereinafter also described as “normal store (flagship store)”), and the labor-saving store managed by the flagship store is referred to as a branch store (hereinafter also referred to as “labor-saving store (branch store)”). The normal store (flagship store) and the labor-saving store (branch store) may be located on different floors or the like in the same building, or may be located in different nearby buildings.

The store system 100 of a normal store or a labor-saving store places an order with the head office system 200 for products to replenish the stock of the own store. The head office system 200 transmits a delivery instruction of a product to be delivered to the store to a distribution center or the like. The distribution center or the like delivers the product instructed by the head office system 200 to each store 1. Here, the product of the labor-saving store (branch store) is once delivered to the normal store (flagship store) together with a product of the normal store (flagship store). Then, the product of the labor-saving store (branch store) is delivered from the normal store (flagship store) to the labor-saving store (branch store) by, for example, an employee or the like of the normal store (flagship store).

In the labor-saving store (branch store), for example, an employee of the normal store (flagship store) stays as necessary for taking out delivered products, cleaning the store, maintenance of equipment, and replenishing and collecting cash. The labor-saving store (branch store) may be a store in which a minimum number of employees is stationed, or may be an unattended store having a time zone in which no employee is present (no employee is stationed).

The labor-saving store may be managed by the head office instead of the flagship store. The products of the labor-saving store may be directly delivered from the distribution center to the labor-saving store. Products to be assorted in the labor-saving store (branch store) may be ordered by the store system 100 of the normal store (flagship store) instead of the labor-saving store (branch store). In this case, the store system 100 can also increase or decrease the order quantity by using the number of times the stock of the labor-saving store (branch store) becomes insufficient or the moved stock quantity. Specifically, the store system 100 can increase the order quantity by a predetermined number (predetermined multiplying factor) when the number of times the stock becomes insufficient is equal to or more than a predetermined value, or increase the order quantity by a predetermined number (predetermined multiplying factor) according to the moved stock quantity.

In the example of FIG. 2, the stores 1A and 1B are labor-saving stores (branch stores), the store 1C is a normal store (flagship store), and the store 1D is another normal store. However, the present invention is not limited thereto, and the stores 1A to 1D may be normal stores, or the stores 1A to 1D may be labor-saving stores.

Referring to FIG. 1, the store system 100 includes a point of sale (POS) device 110, a store server (also referred to as an inventory management server) 120, store terminals 130a, 130b, and 130c (hereinafter described as store terminals 130a to 130c), and a camera 140. The store server 120 of the flagship store is also referred to as a first server, and the store server 120 of the branch store is also referred to as a second server.

The store terminals 130a to 130c are mobile communication terminals used by employees, and may be held by each employee or installed in each store (flagship store or the like). Each of the store terminals 130a to 130c is a portable computer, and includes at least an operation unit and a display unit (both not illustrated). The store terminals 130a to 130c may be touch panel type tablet terminals, or may be devices including a display device on a display unit and physical buttons on an operation unit. The store terminals 130a to 130c transmit and receive inventory information and the like to and from the store server 120 of the own store 1 according to an operation on the operation unit by an employee, and display the inventory information on the display unit. Further, when a stock replenishment request or the like to the employee is received from the head office system 200 or the store server 120, an indication thereof is displayed on the display unit. The store terminals 130a to 130c are necessary components in the flagship store 1C where the employee is stationed, but are not necessary components in the branch stores 1A and 1B where no employee is stationed. In the branch stores 1A and 1B, the employee may carry the store terminal 130a to 130c of the flagship store 1C and perform inventory replenishment processing, or may perform the inventory replenishment processing using the store terminals 130a to 130c provided in the branch stores 1A and 1B.

The camera 140 is a camera that is installed in a store and captures an image of the inside of the store. A plurality of cameras 140 may be present in one store.

The POS device 110 performs a payment process (for example, reading and registering a barcode or the like of a product in a shopping list, and performing a settlement of the product in the shopping list) when a customer who has visited the store 1 purchases the product. The POS device 110 may specify an identifier (ID) for identifying a customer who purchases a product.

For example, the registration and settlement of a product may be in the form of being performed by an operation of an employee of the store 1, or in the form of being performed by an operation of a customer. The registration of a product may be in the form of being performed by an operation of the employee of the store 1, and the settlement may be in the form of being performed by an operation of a customer.

The POS device 110 includes a registration unit 111, a settlement unit 112, a specification unit 113, and a transmission unit 114. The POS device 110 may be connected with a camera 115, a barcode reader 116, a tag reader-writer 117, and a card reader-writer 118.

The registration unit 111 registers a product to be purchased by a customer. Here, for example, the registration unit 111 instructs the camera 115 or the barcode reader 116 connected to the POS device 110 to read a two-dimensional code such as a QR code (registered trademark) or a barcode representing the product ID given to the product, further specifies the product based on data of the read two-dimensional code or barcode, and registers the product in the shopping list. Similarly, the registration unit 111 may cause the tag reader-writer 117 to read an IC tag given to the product and having a product ID written therein, thereby specifying the product and registering the product in the shopping list. The registration unit 111 may specify the product by image recognition using a product image captured by the camera 115 and register the product in the shopping list. The registration unit 111 may specify the product removed from a product shelf or the like by a customer by image recognition from an image of the inside of the store captured by another camera 140 installed in the store 1, and register the product in the shopping list. The registration unit 111 outputs information of the products registered in the shopping list to the settlement unit 112.

The settlement unit 112 performs a settlement of a product purchased by a customer. Here, the settlement unit 112 processes a payment of the price of the registered product using cash, electronic money, a credit card, two-dimensional code payment, bar code payment, or the like. For example, the settlement unit 112 acquires information of a credit card or electronic money in a magnetic form or a contactless IC card form presented by the customer by the card reader-writer 118 connected to the POS device 110, and processes the payment. The settlement unit 112 may process the payment by acquiring information of a two-dimensional code or a barcode displayed on a payment application operating on a terminal of the customer by the camera 115 or the barcode reader 116. The settlement unit 112 may specify the customer by face image authentication using a face image of the customer acquired by the camera 115 or the camera 140, and process the payment using electronic money, a credit card, a bank account, or the like registered in advance in association with the customer. In this case, the settlement unit 112 may specify a member by, for example, checking the feature amount of a face image with the feature amount of a face image registered in advance in association with the member ID of the chain. The settlement unit 112 may specify the member by another biometric authentication means such as iris authentication, fingerprint authentication, or vein authentication. The settlement unit 112 generates purchase information for each settlement as a unit. The purchase information is procurement information of the customer for describing on a receipt generated by a general POS device 110. The purchase information includes, for example, a customer ID, a settlement date and time, a purchased product, a product amount, and a total purchase amount. The settlement unit 112 transmits the purchase information generated for each settlement to the transmission unit 114.

The specification unit 113 specifies a customer ID for identifying the customer who purchases a product. For example, the specification unit 113 acquires a member (customer) ID from a membership card in a magnetic form or a contactless IC card form presented by the customer by the card reader-writer 118. The specification unit 113 may acquire the member ID from a barcode or a two-dimensional code displayed in a member application operating on a terminal of the customer by the camera 115 or the barcode reader 116. The specification unit 113 may specify the member ID by biometric authentication means such as face image authentication using the face image of the customer described above. The specification unit 113 delivers the specified customer ID to the settlement unit 112. The settlement unit 112 may describe the customer ID on the receipt. Cumulative points associated with the customer ID (cumulative value of points granted according to the procurement amount) may be described on the receipt.

Upon receiving the purchase information from the settlement unit 112, the transmission unit 114 transmits the purchase information to the store server 120.

The store server 120 includes an inventory storage unit 121, an inventory update unit 122, a generation unit 123, a notification unit 124, and a movement storage unit 125.

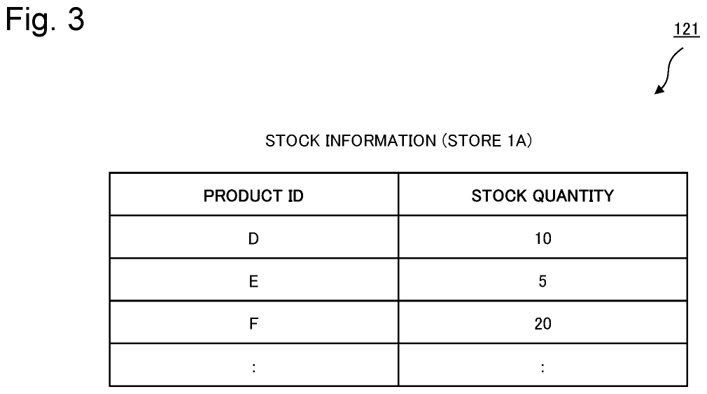

The inventory storage unit 121 stores inventory information. The inventory information includes at least IDs for identifying a plurality of products sold in each store and respective stock quantities of the products (see FIG. 3). The inventory information may include a threshold for each product (a value for determining that the stock is insufficient when it becomes equal to or less than the threshold).

The movement storage unit 125 stores a movement distance or a movement time of the employee among the stores 1A to 1C.

When a product is purchased through the POS device 110, the inventory update unit 122 updates the inventory information of the product. Specifically, when the store server 120 receives the purchase information from the transmission unit 114 of the POS device 110, the inventory update unit 122 updates the inventory information on the basis of the purchase information. For example, when the stock quantity of a certain product is five and the purchase quantity is one, a value obtained by subtracting the purchase quantity from the stock quantity, that is, four is registered in the inventory storage unit 121 as inventory information as a new stock quantity. The purchase information includes at least a branch store ID capable of specifying a branch store, a product ID, and the number of products purchased. The inventory update unit 122 determines whether the stock quantity of the product is equal to or less than a threshold of the product stored in the inventory storage unit 121 as a result of the update, and transmits a notification of stock shortage to the generation unit 123 when the stock quantity is equal to or less than the threshold.

The generation unit 123 generates stock shortage information including information for specifying a branch store and a stock quantity of a product when the stock quantity of the product in the branch store in which an employee of a flagship store replaces the product is equal to or less than a threshold. The generation unit 123 generates the stock shortage information including information for specifying at least one of the flagship store or the branch store on the basis of a stock quantity of the product equal to or less than a threshold in the flagship store and a stock quantity of the product equal to or less than a threshold in a plurality of the branch stores.

Upon receiving the notification of the stock shortage from the inventory update unit 122, the generation unit 123 generates the stock shortage information including at least the branch store ID, the product ID, and the stock quantity of the product. For example, in FIG. 3, the stock quantity of a product with a product ID “E” is five. Here, when the threshold of the stock quantity is five, the generation unit 123 generates the stock shortage information in which the information for specifying the branch store is, for example, “store 1A” and the stock quantity of the product with the product ID “E” is “five”. The generation unit 123 transmits the stock shortage information to the store terminals 130a to 130c via the notification unit 124.

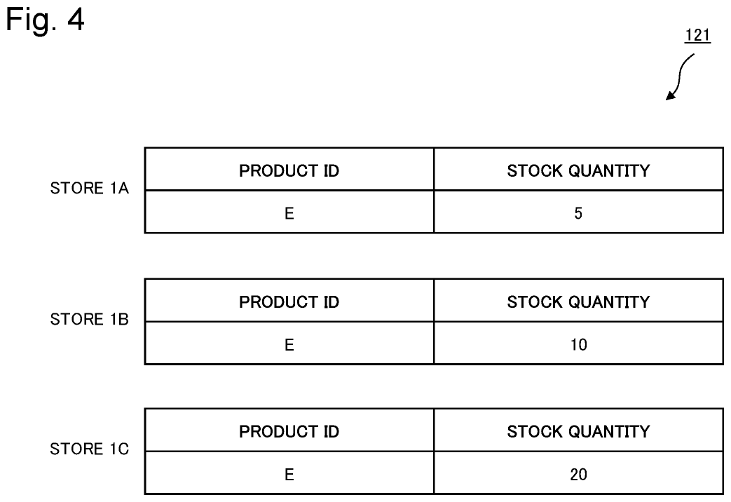

The generation unit 123 may generate the stock shortage information including information for specifying the flagship store or the branch store on the basis of the stock quantity of the flagship store corresponding to a certain product and the stock quantities of the plurality of branch stores corresponding to a certain product. Specifically, when the stock (product) is moved between the flagship store and each of the plurality of branch stores, the stock shortage information may include information for specifying a movement origin store and a movement destination store, the product ID to be moved, and the moving stock quantity. Describing with reference to FIG. 2, it is assumed that the stock of a specific product is insufficient in the branch store 1A, and the stock of the specific product exceeds the threshold in the flagship store 1C or another branch store 1B near the branch store 1A. In this case, the generation unit 123 generates a notification of product movement (stock shortage information) so that the number of specific products of the branch store 1A exceeds the threshold for a store having a larger stock quantity out of the flagship store 1C or the branch store 1B in which the stock exceeds the threshold. For example, in the case of the inventory information data as illustrated in FIG. 4, when the generation unit 123 extracts the stock quantity of other stores for the product E in shortage of stock in the store 1A, the stock quantity of the product E is 10 in the store 1B, and the stock quantity of the product E is 20 in the store 1C. In this case, since the difference in the stock quantity between the store 1B and the store 1C is 10, the stock shortage information is generated so as to carry the product E from the store 1C having a larger stock to the store 1A. At this time, it is assumed that the generation unit 123 is set in advance to hold the stock from a store with a large stock if the difference in the stock quantity is equal to or more than 10. The store terminals 130a to 130c receive the stock shortage information from the notification unit 124 and display the stock shortage information on the display unit. An employee who sees this display moves the specific product from the store having a larger stock quantity to the branch store 1A by the notified number. As the movement is completed, the employee updates the inventory information data (see FIG. 4 and the like) via the store terminal 130a to 130c. The movement may be performed not by the employee but by a third party. For example, a first employee sends a product based on the stock shortage information displayed on the store terminal 130a of the first employee. A second employee who has received the product that has been sent inputs that the delivery has been completed via the store terminal 130b of the second employee. Upon receiving the input of the delivery completion, the inventory update unit 122 updates the inventory information data of the inventory storage unit 121.

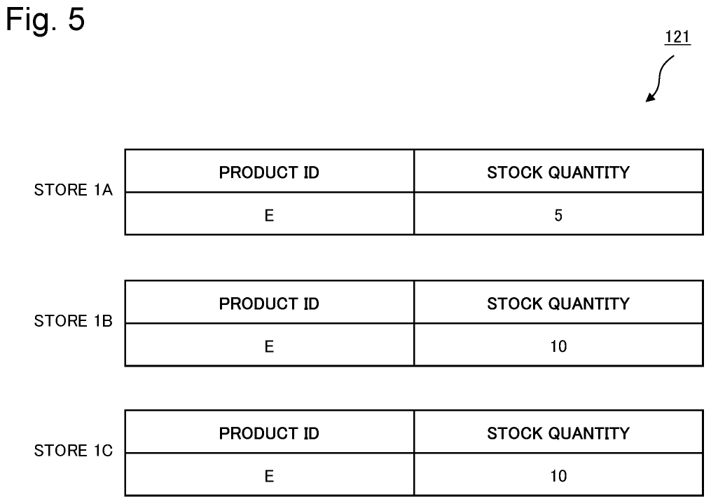

Furthermore, when the stock quantity of a product in the flagship store or the stock quantity of a product in the plurality of branch stores associated with a certain product is equal to or less than the threshold of the product, the generation unit 123 may select the flagship store or the plurality of branch stores to which the stock is to be moved on the basis of the movement distance or the movement time necessary for moving from one to another. The generation unit 123 may include information for specifying the flagship store or the branch store selected as the movement origin or the movement destination in the stock shortage information. Specifically, it is assumed that the stock of a specific product is short in the branch store 1A and the stock of the specific product exceeds the threshold in the flagship store 1C or the another branch store 1B near the branch store 1A, but the number of the specific products is substantially the same. For example, it is assumed that the threshold for determining that the product E is in shortage of stock is five. At this time, the product E in the store 1A illustrated in FIG. 5 is in shortage of stock. It is assumed that when the generation unit 123 extracts the stock quantity of other stores for the product E, the store 1B has the stock quantity of the product E of 10 and the store 1C also has the stock quantity of the product E of 10. In this case, the generation unit 123 extracts, from the movement storage unit 125, a store having the shortest movement distance or movement time to the branch store 1A out of the flagship store 1C or the branch store 1B in which the stock exceeds the threshold, and generates the stock shortage information including replenishment of the stock of the branch store 1A, that is, information of movement of products for which the number of specific products in the branch store 1A exceeds the threshold, for the extracted store. The stock shortage information may be generated so as to move the stock from a plurality of stores such as the flagship store 1C and the branch store 1B. The store terminals 130a to 130c receive the stock shortage information from the notification unit 124 and display the stock shortage information on the display unit. The employee who sees this display moves the specific product by the notified quantity from the store with a shorter movement distance or movement time to the branch store 1A. At this time, a position-identifiable device of GPS, WiFi (registered trademark), or the like may be mounted on the store terminal 130a to 130c, and the movement distance or the movement time from the current position of the employee who holds the store terminal 130a to 130c to the branch store 1A may be measured. For example, when the movement distance (movement time) is shorter from the store 1B to the store 1A but the employee (store terminal 130a to 130c) is in the flagship store 1C, and the total movement distance of the employee is shorter from the store 1C to the store 1A, the inventory information may be presented so as to replenish the stock from the store 1C to the store 1A.

Here, the movement distance is a movement distance in a three-dimensional vector space including latitude, longitude, and altitude. That is, a movement from the first floor to the tenth floor and a movement from the twentieth floor to the first floor in the same building are also targets of comparison.

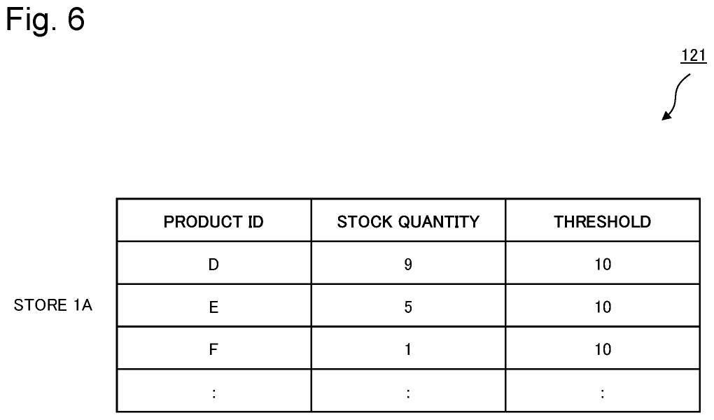

In a case where there is a plurality of products of which the stock quantity is equal to or less than a preset threshold, the generation unit 123 may generate a list in which stock quantities equal to or less than the threshold are arranged in ascending order and set the list as the stock shortage information. For example, as illustrated in FIG. 6, it is assumed that there are products with product IDs “D”, “E”, and “F” in the store 1A, the stock quantities thereof are “9”, “5”, and “1”, respectively, and the thresholds thereof are “10”, “10”, and “10”, respectively. In this case, the generation unit 123 generates the list in the order of “1 (product F)”, “5 (product E)”, and “9 (product D)” in which the stock quantity greatly deviates from the threshold, and sets the list as the stock shortage information.

The notification unit 124 transmits the stock shortage information and the like generated by the generation unit 123 to the store terminal (for example, 130a). The store terminal 130a is provided with an input device, for example, an input button (“ACCEPT”, “REJECT”, or the like) for replying to the received notification or the like, and the employee replies to the notification unit 124 via the input device. The notification unit 124 receives a reply of “accepted (leaving for stock replenishment)” from the store terminal 130a that has notified of the stock shortage information. When there is no reply of acceptance within a predetermined time from the store terminal 130a that has been notified of the stock shortage information, the notification unit 124 may notify a store terminal (for example, 130b, 130c) other than the store terminal of the stock shortage information. The stock shortage information may be transmitted to all the store terminals 130a to 130c to prompt the employee to replenish the stock, or may be transmitted only to the specific store terminal 130a.

### Operation of Inventory Management System

An operation of the first example embodiment will be described.

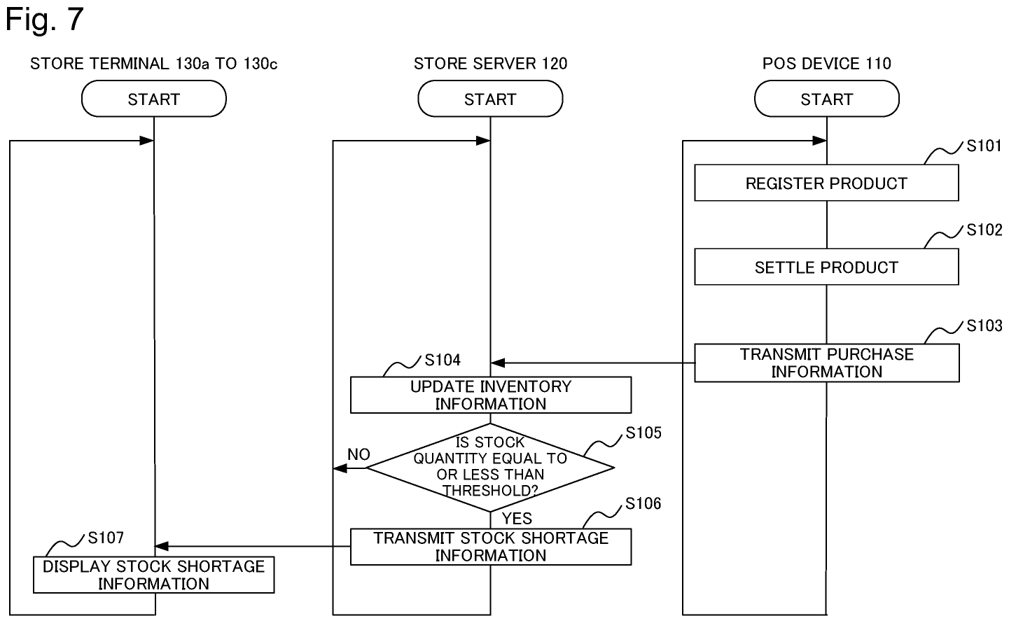

FIG. 7 is a flowchart illustrating inventory management processing in the first example embodiment. The inventory management processing is executed, for example, every time a customer purchases a product at each store 1.

The registration unit 111 of the POS device 110 in the store system 100 in each store 1 registers a product to be purchased by a customer (step S101). The settlement unit 112 performs a settlement of a product purchased by a customer (step S102). The transmission unit 114 transmits the purchase information to the store server 120 (step S103).

The inventory update unit 122 of the store server 120 updates the inventory information of the own store 1 on the basis of the received purchase information (step S104). The inventory update unit 122 determines whether the stock quantity of the product is equal to or less than the threshold as a result of the update (step S105), and notifies the generation unit 123 of stock shortage when the stock quantity is equal to or less than the threshold. The generation unit 123 generates the stock shortage information including at least the branch store ID of the stock shortage, the product ID, and the stock quantity of the product, and the notification unit 124 transmits the stock shortage information to the store terminals 130a to 130c (step S106).

The store terminals 130a to 130c display the received stock shortage information on the display unit to prompt the employee to replenish the stock (step S107).

Thus, the operation of the first example embodiment is completed.

### Modification Example 1

In step S106, when the stock of a specific product is insufficient in the branch store 1A (see FIG. 2) and the stock of the specific product is equal to or more than a threshold in the flagship store 1C or the another branch store 1B near the branch store 1A, the generation unit 123 may generate the stock shortage information so as to move the product for stock replenishment from a store having a larger stock quantity.

### Modification Example 2

In step S106, when the stock of a specific product is insufficient in the branch store 1A (see FIG. 2), and the stock of the specific product is equal to or more than a threshold in the flagship store 1C or the another branch store 1B near the branch store 1A but the number of the specific product is substantially the same, the generation unit 123 may extract the store having the smallest movement distance or movement time to the branch store 1A from the movement storage unit 125, and generate the stock shortage information so as to replenish the stock from the extracted store.

### Modification Example 3

In step S107, after the stock shortage notification is transmitted to the specific store terminal 130a, when there is no reply indicating to leave for stock replenishment within a predetermined time, the notification unit 124 may notify a store terminal (for example, 130b, 130c) other than the store terminal of the stock shortage information.

In step S107, the notification unit 124 may transmit the stock shortage information to all the store terminals 130a to 130c and receive a reply of acceptance from any of the store terminals 130a to 130c.

### Effect of First Example Embodiment

According to the first example embodiment, inventory management can be efficiently performed in a specific store such as a labor-saving store. A reason thereof is that the generation unit 123 generates the stock shortage information only when the stock quantity of a certain product is equal to or less than the threshold, and the notification unit 124 transmits the stock shortage information to the store terminals 130a to 130c.

A further reason is that the store terminals 130a to 130c display the received stock shortage information to prompt the employees to replenish the stock.

### Second Example Embodiment

The second example embodiment will be described.

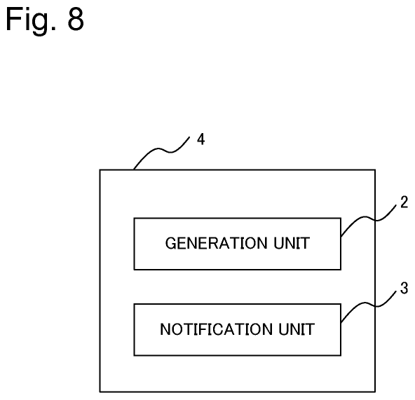

FIG. 8 is a block diagram illustrating a configuration of an inventory management server 4 in the second example embodiment. The inventory management server 4 includes a generation unit 2 and a notification unit 3. The generation unit 2 and the notification unit 3 are example embodiments of a generation means and a notification means, respectively.

The generation unit 2 generates stock shortage information including information for specifying a branch store and a stock quantity of a product when the stock quantity of the product in the branch store in which an employee of a flagship store replaces the product is equal to or less than a threshold. The notification unit 3 notifies a store terminal of the stock shortage information.

An effect of the second example embodiment will be described.

According to the second example embodiment, inventory management can be efficiently performed in a specific store such as a labor-saving store. A reason thereof is that when a stock quantity of a product is equal to or less than the threshold in a branch store in which the employee of the flagship store replaces a plurality of products, the generation unit 2 generates the stock shortage information including the information for specifying the branch store and the stock quantity of the product, and the notification unit 3 notifies the store terminal of the stock shortage information.

### Hardware Configuration Example

In each of the above-described example embodiments, the components of each device (POS device 110, store server 120, store terminals 130a to 130c, or the like) indicate blocks of functional units. Some or all of the components of each device may be achieved by any combination of a computer 500 and a program.

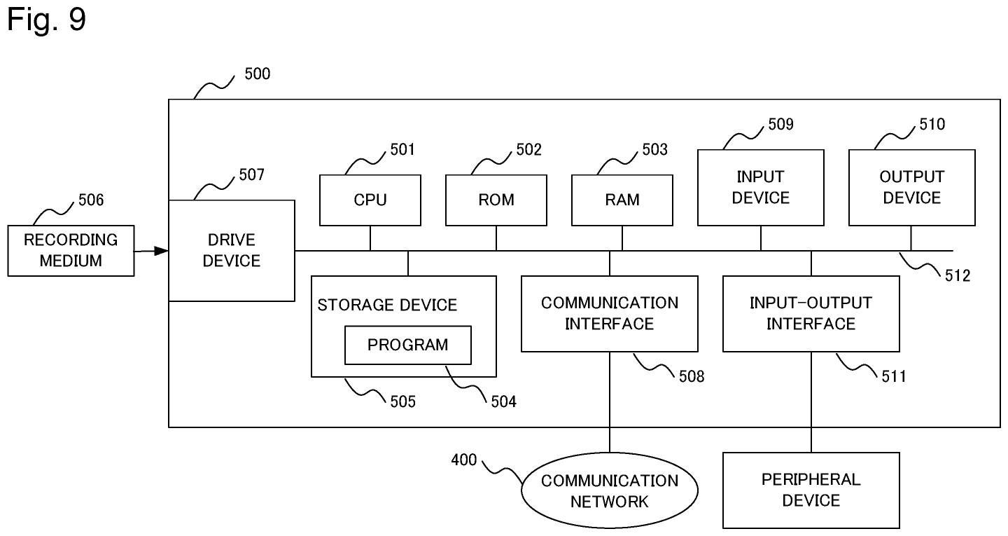

FIG. 9 is a block diagram illustrating an example of a hardware configuration of the computer 500. Referring to FIG. 9, the computer 500 includes, for example, a central processing unit (CPU) 501, a read only memory (ROM) 502, a random access memory (RAM) 503, a program 504, a storage device 505, a drive device 507, a communication interface 508, an input device 509, an output device 510, an input-output interface 511, and a bus 512.

The program 504 includes instructions for achieving the functions of each device. The program 504 is stored in advance in the ROM 502, the RAM 503, and/or the storage device 505. The CPU 501 achieves the functions of each device by executing instructions included in the program 504. For example, the CPU 501 of the store server 120 executes instructions included in the program 504 to implement the functions of the inventory update unit 122, the generation unit 123, and the notification unit 124. The RAM 503 may store data to be processed in the functions of each device. For example, the RAM 503 of the store server 120 may store data of the inventory storage unit 121 and the movement storage unit 125.

The drive device 507 reads and/or writes on the recording medium 506. The communication interface 508 provides an interface with a communication network. The input device 509 includes, for example, a mouse, a keyboard, and/or the like, and receives an input of information from an administrator or the like. The output device 510 is, for example, a display and outputs (displays) information to an administrator or the like. The input-output interface 511 provides an interface with a peripheral device. In a case of the POS device 110, the camera 115, the barcode reader 116, the tag reader-writer 117, and the card reader-writer 118 described above are connected to the input-output interface 511. The bus 512 connects these hardware components. The program 504 may be supplied to the CPU 501 via a communication network, or may be stored in the recording medium 506 in advance, read by the drive device 507, and supplied to the CPU 501.

The hardware configuration illustrated in FIG. 9 is an example, and other components may be added or some components may not be included.

There are various modification examples of the implementation method of each device. For example, each device may be achieved by any combination of a computer and a program different for each of the components. A plurality of components included in each device may be achieved by any combination of one computer and a program.

Some or all of the components of each device may be achieved by general-purpose or dedicated circuitry including a processor or the like, or a combination thereof. These circuits may be configured by a single chip or may be configured by a plurality of chips connected via a bus. Some or all of the components of each device may be achieved by a combination of the above-described circuit or the like and a program.

In a case where some or all of the components of each device is achieved by a plurality of computers, circuits, and the like, the plurality of computers, circuits, and the like may be arranged in a centralized manner or in a distributed manner.

The store server 120 may be arranged in the store 1, or may be disposed in a place different from the store 1 and connected to the POS 110 and the store terminals 130a to 130c via a communication network. That is, the store server 120 may be achieved by a cloud computing system. Similarly, the head office server 210 may also be achieved by a cloud computing system.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. The configurations in the example embodiments can be combined with each other without departing from the scope of the present disclosure.

Some or all of the example embodiments described above may also be described as in the following supplementary notes, but are not limited to the following.

### Supplementary Note 1

An inventory management server including:

a generation means for generating stock shortage information including information for specifying a branch store and a stock quantity of a product when the stock quantity of the product in the branch store in which an employee of a flagship store replaces the product is equal to or less than a threshold; and

a notification means for notifying the store terminal of the stock shortage information.

### Supplementary Note 2

The inventory management server according to supplementary note 1, in which the generation means generates the stock shortage information including information for specifying at least one of the flagship store or the branch store based on a stock quantity of the product equal to or less than a threshold in the flagship store and a stock quantity of the product equal to or less than a threshold in a plurality of the branch stores.

### Supplementary Note 3

The inventory management server according to supplementary note 1 or 2, in which the generation means selects at least one of the flagship store or the plurality of branch stores based on at least one of a movement time or a movement distance necessary for moving from one to another, and generates the stock shortage information including information for specifying the selected at least one of the flagship store or the branch stores when a stock quantity of the product equal to or less than the threshold in the flagship store and a stock quantity of the product equal to or less than the threshold in the plurality of branch stores do not exceed a predetermined number.

### Supplementary Note 4

The inventory management server according to any one of supplementary notes 1 to 3, in which when there is a plurality of products of which the stock quantity is equal to or less than a preset threshold, the generation means arranges the stock quantities equal to or less than the threshold in ascending order, and preferentially generates the stock shortage information along the arranged order.

### Supplementary Note 5

The inventory management server according to any one of supplementary notes 1 to 4, further including an inventory update means for updating a stock quantity based on purchase information of the product by a customer, determining whether the stock quantity of the product is equal to or less than a threshold as a result of the update, and notifying the generation means that the stock quantity of the product is less than the threshold when the stock quantity of the product is less than the threshold.

### Supplementary Note 6

The inventory management server according to supplementary note 5, in which the inventory update means further determines whether the stock quantity of the product exceeds a predetermined quantity.

### Supplementary Note 7

The inventory management server according to supplementary note 1, in which the notification means notifies the stock shortage information to a store terminal other than the store terminal when there is no reply from the store terminal that has been notified of the stock shortage information within a predetermined time.

### Supplementary Note 8

The inventory management server according to supplementary note 3, in which the movement distance is a distance in a three-dimensional vector space.

### Supplementary Note 9

The inventory management server according to supplementary note 3, in which when the stock quantity of the flagship store and the stock quantity of the plurality of branch stores associated with a certain product do not exceed a predetermined quantity, the generation means selects at least one of the flagship store or the plurality of branch stores for which at least either a movement time or a movement distance necessary for moving from one to another is smallest.

### Supplementary Note 10

An inventory management system including:

a first server that manages an inventory of a flagship store;

a second server that manages an inventory of a branch store in which an employee of the flagship store replaces a product; and

a store terminal,

in which the second server is communicably connected to the store terminal,

the second server includes a generation means for generating stock shortage information including information for specifying the branch store and a stock quantity of the product when the stock quantity of the product in the branch store is equal to or less than a threshold, and a notification means for notifying the store terminal of the stock shortage information, and

the store terminal includes a display unit that displays inventory information based on the stock shortage information.

### Supplementary Note 11

An inventory management method including:

generating stock shortage information including information for specifying a branch store and a stock quantity of a product when the stock quantity of the product in the branch store in which an employee of a flagship store replaces the product is equal to or less than a threshold; and

notifying the store terminal of the stock shortage information.

### Supplementary Note 12

A recording medium storing an inventory management program causing a computer to execute processing including:

generating stock shortage information including information for specifying a branch store and a stock quantity of a product when the stock quantity of the product in the branch store in which an employee of a flagship store replaces the product is equal to or less than a threshold; and

notifying the store terminal of the stock shortage information.

This application is based upon and claims the benefit of priority from Japanese patent application No. 2019-054131, filed on Mar. 22, 2019, the disclosure of which is incorporated herein in its entirety by reference.

### REFERENCE SIGNS LIST

1 Store
1A Branch store
1B Branch store
1C Flagship store
2 Generation unit
3 Notification unit
4 Inventory management server
100 Store system
110 POS device
111 Registration unit
112 Settlement unit
113 Specification unit
114 Transmission unit
115 Camera
116 Barcode reader
117 Tag reader-writer
118 Card reader-writer
120 Store server (inventory management server)
121 Inventory storage unit
122 Inventory update unit
123 Generation unit
124 Notification unit
125 Movement storage unit
130a Store terminal
130b Store terminal
130c Store terminal
140 Camera
200 Head office system
210 Head office server
500 Computer
501 CPU
502 ROM
503 RAM
504 Program
505 Storage device
506 Recording medium
507 Drive device
508 Communication interface
509 Input device
510 Output device
511 Input-output interface
512 Bus

What is claimed is:

1. An inventory management server comprising:
a memory; and
at least one processor coupled to the memory,
the at least one processor performing operations to:
generate stock shortage information including information for specifying a branch store and a stock quantity of a product when the stock quantity of the product in the branch store in which an employee of a flagship store replaces the product is equal to or less than a threshold; and
notify the store terminal of the stock shortage information.

2. The inventory management server according to claim 1, wherein the at least one processor is further configured to execute the instructions to generate the stock shortage information including information for specifying at least one of the flagship store or the branch store based on a stock quantity of the product equal to or less than a threshold in the flagship store and a stock quantity of the product equal to or less than a threshold in a plurality of the branch stores.

3. The inventory management server according to claim 1, wherein the at least one processor is further configured to execute the instructions to
select at least one of the flagship store or the plurality of branch stores based on at least one of a movement time or a movement distance necessary for moving from one to another, and
generate the stock shortage information including information for specifying the selected at least one of the flagship store or the branch stores when a stock quantity of the product equal to or less than the threshold in the flagship store and a stock quantity of the product equal to or less than the threshold in the plurality of branch stores do not exceed a predetermined number.

4. The inventory management server according to claim 1, wherein the at least one processor is further configured to execute the instructions to
arrange the stock quantities equal to or less than the threshold in ascending order, and
generate the stock shortage information along the arranged order preferentially when there is a plurality of products of which the stock quantity is equal to or less than a preset threshold.

5. The inventory management server according to claim 1, wherein the at least one processor is further configured to execute the instructions to
update means for updating update a stock quantity based on purchase information of the product by a customer,
determine whether the stock quantity of the product is equal to or less than a threshold as a result of the update, and
notify the generation means that the stock quantity of the product is less than the threshold when the stock quantity of the product is less than the threshold.

6. The inventory management server according to claim 5, wherein the at least one processor is further configured to execute the instructions to determine whether the stock quantity of the product exceeds a predetermined quantity.

7. The inventory management server according to claim 1, wherein the at least one processor is further configured to execute the instructions to notify the stock shortage information to a store terminal other than the store terminal when there is no reply from the store terminal that has been notified of the stock shortage information within a predetermined time.

8. The inventory management server according to claim 3, wherein the movement distance is a distance in a three-dimensional vector space.

9. The inventory management server according to claim 3, wherein the at least one processor is further configured to execute the instructions to select at least one of the flagship store or the plurality of branch stores for which at least either a movement time or a movement distance necessary for moving from one to another is smallest when the stock quantity of the flagship store and the stock quantity of the plurality of branch stores associated with a certain product do not exceed a predetermined quantity.

10. An inventory management system comprising:
a first server that manages an inventory of a flagship store;
a second server that manages an inventory of a branch store in which an employee of the flagship store replaces a product; and
a store terminal,
wherein the second server is communicably connected to the store terminal,
the second server including
a memory; and
at least one processor coupled to the memory,
the at least one processor performing operations to:
generate stock shortage information including information for specifying the branch store and a stock quantity of the product when the stock quantity of the product in the branch store is equal to or less than a threshold, and notify the store terminal of the stock shortage information, and
the store terminal includes a display unit that displays inventory information based on the stock shortage information.

11. An inventory management method comprising:
generating stock shortage information including information for specifying a branch store and a stock quantity of a product when the stock quantity of the product in the branch store in which an employee of a flagship store replaces the product is equal to or less than a threshold; and
notifying the store terminal of the stock shortage information.

12. (canceled)
